(19) United States
(12) Patent Application Publication
(10) Pub. No.: US 2025/0276662 A1
(43) Pub. Date: Sep. 4, 2025

(54) Front Bumper Assembly Support in Vehicles

(71) Applicant: Nissan North America, Inc., Franklin, TN (US)

(72) Inventors: Erin Maroney, Orchard Lake, MI (US); Gary Eberhard, Oxford, MI (US); Demetrios Golematis, Farmington Hills, MI (US)

(21) Appl. No.: 18/591,710

(22) Filed: Feb. 29, 2024

(51) Int. Cl. B60R 19/50; B60R 19/02; B60R 19/18; B60R 19/52; B62D 65/16

(52) U.S. Cl. CPC B60R 19/50; B60R 19/02; B60R 19/52; B62D 65/16; B60R 2019/1886; B60R 2019/505; B60R 2019/527

(57) ABSTRACT

A vehicle that includes: a vehicle body; a reinforcement member that is supported by the vehicle body and which is configured to absorb forces during an impact with the vehicle; a front bumper assembly that is supported by the vehicle body and which includes front lamps; an apron bracket that is supported by the vehicle body and which extends into the front bumper assembly; and support brackets that extends between the reinforcement member and the apron bracket to thereby inhibit movement of the front bumper assembly in relation to the vehicle body.

### TECHNICAL FIELD

The present application relates to supporting the front bumper assembly of a vehicle in order to inhibit (if not entirely prevent) relative movement between the front bumper assembly and the body of the vehicle.

### BACKGROUND

The front bumper assembly of a vehicle includes a variety of components such as, for example, a fascia subassembly, a grille subassembly, and front lamps (e.g., headlights). Depending on the configuration of the vehicle, the weight of the front bumper assembly can be substantial, creating the potential for movement of the front bumper assembly in relation to the vehicle body during travel, which can result in damage (e.g., cracking of the grille subassembly).

In order to inhibit (if not entirely prevent) any such damage, the present disclosure describes various structures and methods for increasing support of the front bumper assembly.

### SUMMARY

In one aspect of the present disclosure, a vehicle is disclosed that includes: a vehicle body; a reinforcement member; a front bumper assembly; an apron bracket; and support brackets.

The reinforcement member is supported by the vehicle body and is configured to absorb forces during an impact with the vehicle.

The front bumper assembly is supported by the vehicle body and includes: a fascia subassembly; front lamps that are supported by the fascia subassembly; and a grille subassembly that is supported by the fascia subassembly.

The apron bracket is supported by the vehicle body and the fascia subassembly such that the apron bracket extends therebetween to thereby strengthen the fascia subassembly and improve pedestrian impact performance.

The support brackets extend between the reinforcement member and the apron bracket to thereby inhibit movement of the front bumper assembly in relation to the vehicle body.

In certain embodiments, the support brackets may include generally S-shaped configurations.

In certain embodiments, the support brackets may be generally identical in configuration.

In certain embodiments, the support brackets may include: trunks; first flanges that extend from the trunks in generally orthogonal relation thereto; and second flanges that extend from the trunks in generally orthogonal relation thereto.

In certain embodiments, the first flanges may extend in a first direction, and the second flanges may extend in a second direction that is opposite to the first direction.

In certain embodiments, the first flanges may include retainers that are configured to receive first mechanical fasteners to thereby connect the support brackets to the apron bracket.

In certain embodiments, the retainers may be fixedly connected to the first flanges.

In certain embodiments, the second flanges may include apertures that extend therethrough and which are configured to receive second mechanical fasteners to thereby connect the support brackets to the reinforcement member.

In certain embodiments, the second flanges may further include projections that extend outwardly therefrom and which are configured for engagement with the reinforcement member to inhibit rotation of the support brackets in relation to the reinforcement member and the apron bracket.

In certain embodiments, the reinforcement member may include openings that are configured to receive the projections.

In another aspect of the present disclosure, a vehicle is disclosed that includes: a vehicle body; a reinforcement member that is supported by the vehicle body and which is configured to absorb forces during an impact with the vehicle; a front bumper assembly that is supported by the vehicle body and which includes front lamps; an apron bracket that is supported by the vehicle body and which extends into the front bumper assembly; and support brackets that extend between the reinforcement member and the apron bracket to thereby inhibit movement of the front bumper assembly in relation to the vehicle body.

In certain embodiments, the support brackets may include outer support brackets that are positioned in general alignment with the front lamps along a width of the vehicle.

In certain embodiments, the support brackets may further include at least one inner support bracket that is positioned between the outer support brackets.

In certain embodiments, the at least one inner support bracket may be generally centered along the width of the vehicle.

In certain embodiments, the support brackets may include trunks and upper and lower flanges that extend from the trunks in generally opposite directions and in generally parallel relation.

In another aspect of the present disclosure, a method of assembling a vehicle is disclosed. The method includes: connecting an apron bracket to a vehicle body; connecting a reinforcement member to the vehicle body, wherein the reinforcement member is configured to absorb impact forces; connecting support brackets to the apron bracket and the reinforcement member such that the support brackets extend therebetween; and connecting a front bumper assembly to the vehicle body such that the apron bracket extends into the front bumper assembly, whereby the support brackets inhibit movement of the front bumper assembly in relation to the vehicle body.

In certain embodiments, connecting the support brackets to the apron bracket and the reinforcement member may include connecting first flanges to the apron bracket and connecting second flanges to the reinforcement member such that the first flanges and the second flanges extend in generally opposite directions.

In certain embodiments, connecting the support brackets to the reinforcement member may include inserting projections that extend outwardly from the support brackets into openings in the reinforcement member to thereby inhibit rotation of the support brackets in relation to the reinforcement member and the apron bracket.

In certain embodiments, connecting the support brackets to the apron bracket and the reinforcement member may include connecting outer support brackets to the apron bracket and the reinforcement member such that the outer support brackets are generally aligned with front lamps of the vehicle.

In certain embodiments, connecting the support brackets to the reinforcement member and the apron bracket may include connecting at least one inner support bracket to the reinforcement member and the apron bracket such that the at least one inner support bracket is positioned between the outer support brackets.

### BRIEF DESCRIPTION OF THE DRAWINGS

According to common practice, the various features of the drawings may not be to scale and may be arbitrarily expanded or reduced for clarity.

FIG. 1 is a partial, top, perspective view of a vehicle according to the principles of the present disclosure.

FIG. 2 is a partial, front, perspective view of the vehicle illustrating a bumper beam, an apron bracket, and support brackets.

FIG. 3 is a partial, side, plan view of the vehicle illustrating the bumper beam, the apron bracket, and the support brackets.

FIG. 4 is a front, perspective view of one of the support brackets.

### DETAILED DESCRIPTION

The present disclosure describes a vehicle that includes: a vehicle body; a reinforcement member, which is configured to absorb forces during an impact with the vehicle; a front bumper assembly; an apron bracket, which extends into the front bumper assembly; and support brackets, which extend between the reinforcement member and the apron bracket. The support brackets inhibit (if not entirely prevent) relative movement between the front bumper assembly and the body of the vehicle during travel and, thus, damage to the front bumper assembly that may otherwise occur.

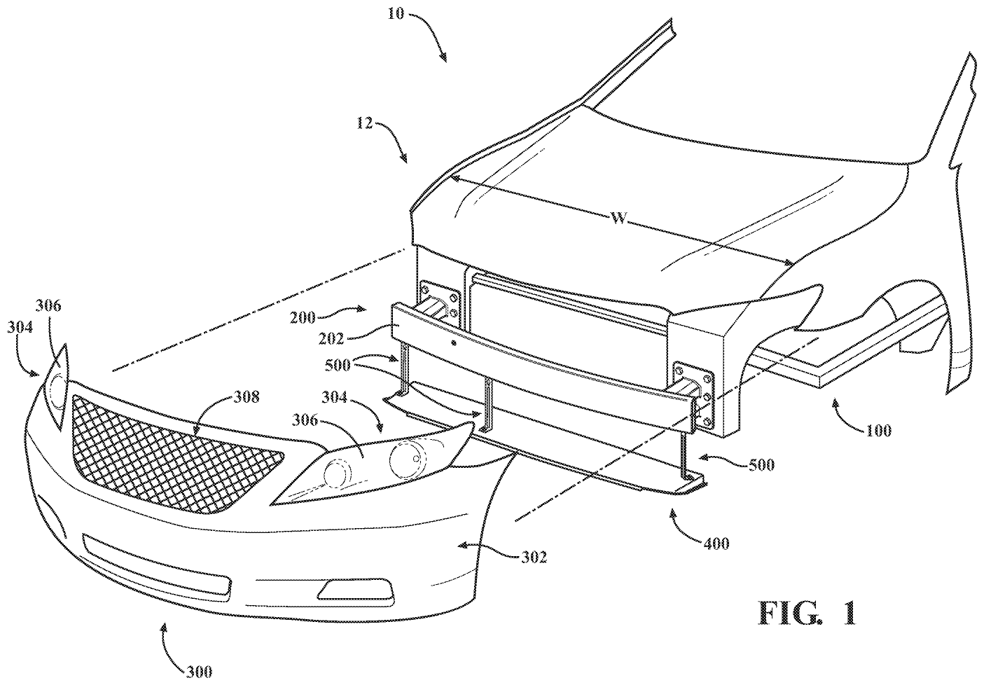

With reference to FIGS. 1-4, a vehicle 10 is disclosed that includes: a vehicle body 100; a reinforcement member 200 (e.g., a crash beam 202); a front bumper assembly 300, which is positioned (located) at a front-end 12 of the vehicle 10; an apron bracket 400; and a plurality of support brackets (stays) 500. Although generally illustrated and described in the context of a passenger vehicle, it should be appreciated that the various components described herein may be configured for use with a wide variety of vehicles (e.g., trucks, SUVs, vans, buses, etc.).

The vehicle body 100 is a structural component that not only provides strength and rigidity to the vehicle 10 but supports and provides a framework for the reinforcement member 200, the front bumper assembly 300, the apron bracket 400, and various other components.

The reinforcement member 200 protects and fortifies the front-end 12 of the vehicle 10 and is positioned (located) rearwardly of the front bumper assembly 300. The reinforcement member 200 is connected (secured, mounted) to (or otherwise supported by) the vehicle body 100 and is configured to absorb force during an impact with the vehicle 10 (e.g., a crash, a collision, etc.). It is envisioned that the reinforcement member 200 may be removably or fixedly (i.e., non-removably) connected to the vehicle body 100 in any suitable manner, including, for example, via mechanical fasteners (e.g., bolts, screws, rivets, pins, clips, or the like), via welding, via integral (e.g., unitary, monolithic) formation therewith, etc.

The front bumper assembly 300 is connected (secured, mounted) to (or otherwise supported by) the vehicle body 100 and extends laterally (e.g., horizontally) along a width W (FIG. 1) of the vehicle 10 (i.e., across the front-end 12). The front bumper assembly 300 includes: a fascia subassembly 302; front lamps 304 (e.g., headlights 306), which are connected (secured, mounted) to (or otherwise supported by) the fascia subassembly 302; and a grille subassembly 308.

The fascia subassembly 302 is positioned (located) and extends axially forward of the vehicle body 100 and the reinforcement member 200. The fascia subassembly 302 supports the front lamps 304 and serves a variety of functions including, for example, improving aerodynamics, contributing to the overall aesthetic appearance of the vehicle 10, and concealing (covering) various components of the vehicle 10.

The grille subassembly 308 is connected (secured, mounted) to (or otherwise supported by) the fascia subassembly 302. Like the fascia subassembly 302, the grille subassembly 308 serves a variety of functions including, for example, contributing to the overall aesthetic appearance of the vehicle 10 and facilitating airflow into the engine compartment.

The apron bracket 400 is connected (secured, mounted) to (or otherwise supported by) the vehicle body 100 and the front bumper assembly 300 (i.e., the fascia subassembly 302) and extends therebetween. More specifically, the apron bracket 400 extends into the front bumper assembly 300 (i.e., the fascia subassembly 302), whereby the apron bracket 400 strengthens the fascia subassembly 302 to improve pedestrian impact performance.

The support brackets 500 extend between the reinforcement member 200 and the apron bracket 400 and are fixedly (i.e., non-movably) connected (secured, mounted) thereto, as described in further detail below. The support brackets 500 inhibit (if not entirely prevent) movement of the front bumper assembly 300 in relation to the vehicle body 100 and, thus, damage to the front bumper assembly 300 (e.g., cracking of the grille subassembly 308) that may otherwise occur during travel of the vehicle 10.

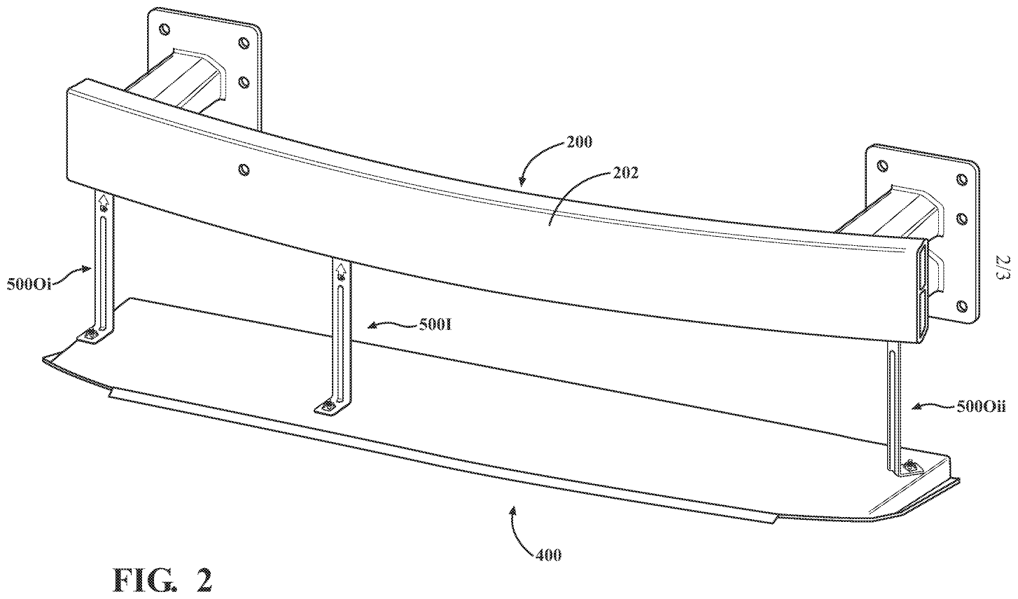

With reference to FIGS. 2-4 in particular, the support brackets 500 will be discussed. The vehicle 10 includes outer support brackets 500O and (one or more) at least one inner support bracket 500I. Although shown as including three support brackets 500 in the illustrated embodiment (i.e., a pair of outer support brackets 500Oi, 500Oii and a single inner support bracket 500I), it is envisioned that the particular number of support brackets 500 may be increased or decreased without departing from the scope of the present disclosure. For example, embodiments in which the vehicle 10 may include two or more inner support brackets 500I also envisioned herein, as are embodiments in which the vehicle 10 may be devoid of the inner support brackets 500I altogether (i.e., embodiments that exclusively include the outer support brackets 500O).

The outer support brackets 500Oi, 500Oii are positioned in general alignment with the front lamps 304 (FIG. 1) (i.e., along the width W of the vehicle 10), which allows the outer support brackets 500O to support the weight thereof and thereby further inhibit (if not entirely prevent) movement of the front bumper assembly 300 in relation to the vehicle body 100.

As seen in FIG. 2, the inner support bracket 500I is positioned (located) between the outer support brackets 500Oi, 500Oii. More specifically, in the illustrated embodiment, the inner support bracket 500I is generally centered along the width W (FIG. 1) of the vehicle 10. Embodiments in which the inner support bracket 500I may be eccentrically positioned (i.e., such that the inner support bracket 500I is located off-center along the width W of the vehicle 10) are also envisioned herein (e.g., to create clearance for additional components of the vehicle 10), however, and would not be beyond the scope of the present disclosure.

The support brackets 500 are generally identical in configuration and include trunks 502 (FIG. 4) and respective lower (first) and upper (second) flanges 504, 506, which extend from the trunks 502 in generally opposite directions, as described in further detail below. More specifically, the support brackets 500 are generally S-shaped in configuration, which creates increased clearance (e.g., vis-à-vis a generally C-shaped configuration) for tooling during installation of the support brackets 500 and connection to the reinforcement member 200 and the apron bracket 400.

The trunks 502 extend between and connect the respective lower and upper flanges 504, 506 and are generally linear in configuration. More specifically, the trunks 502 include lower (first) ends 508, which are connected (secured) to the lower flanges 504, and upper (second) ends 510, which are connected (secured) to the upper flanges 506.

In the illustrated embodiment, the trunks 502 include one or more strengthening members 512 (FIG. 4) (e.g., beads 514, ribs, etc.) and indicators 516 (e.g., arrows 518), which identify the direction of installation. Embodiments of the support brackets 500 that are devoid of the strengthening member(s) 512 and/or the indicators 516 are also envisioned herein, however, and would not be beyond the scope of the present disclosure.

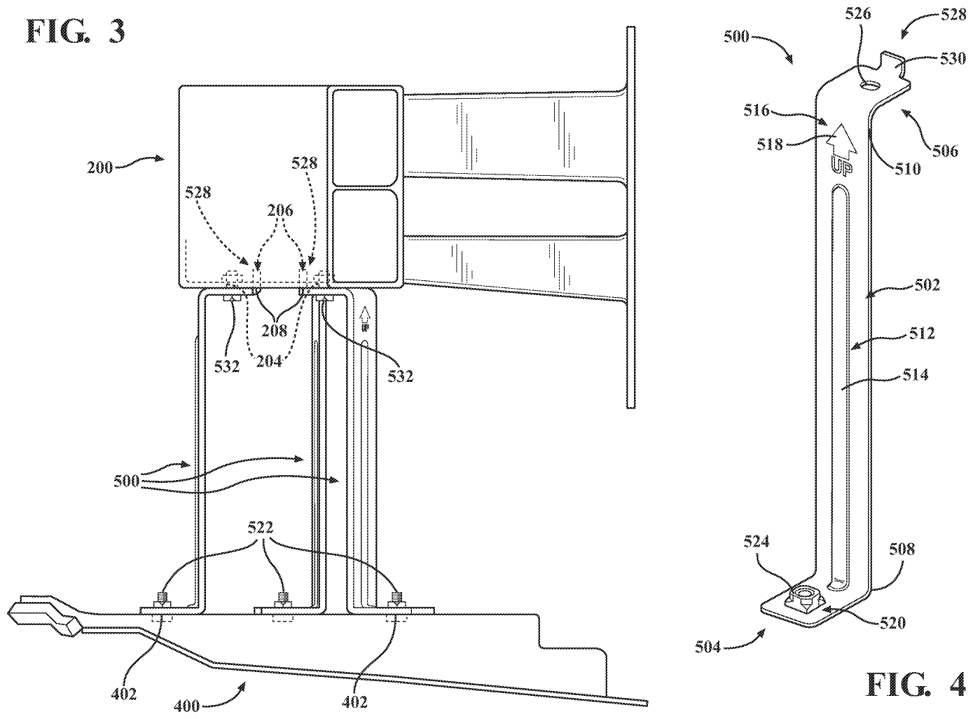

The lower flanges 504 extend from the trunks 502 in generally orthogonal (perpendicular) relation thereto and in a first (i.e., forward) direction. The lower flanges 504 include retainers 520 (FIG. 4) that are configured to receive (first) mechanical fasteners 522 (FIG. 3) (e.g., screws, bolts, etc.) such that the mechanical fasteners 522 extend through the support brackets 500 (via the retainers 520) and into apertures 402 in the apron bracket 400 to thereby connect the support brackets 500 to the apron bracket 400. More specifically, in the illustrated embodiment, the retainers 520 are configured as weld nuts 524 that are fixedly (i.e., non-movably and non-removably) connected to the lower flanges 504.

The upper flanges 506 extend from the trunks 502 in generally orthogonal (perpendicular) relation thereto and in a second (i.e., rearward) direction, which is generally opposite to the first direction. More specifically, the support brackets 500 are configured such that the respective lower and upper flanges 504, 506 extend from the trunks 502 in generally parallel relation.

The upper flanges 506 include apertures 526 and projections 528 (FIGS. 3, 4) (e.g., tabs 530).

The apertures 526 extend through the upper flanges 506 and are configured to receive (second) mechanical fasteners 532 (FIG. 3) (e.g., screws, bolts, etc.) such that the mechanical fasteners 532 extend through the support brackets 500 (via the apertures 526) and into apertures 204 in the reinforcement member 200 to thereby connect the support brackets 500 to the reinforcement member 200.

The projections 528 (FIG. 4) are generally U-shaped in configuration and extend outwardly (i.e., rearwardly and vertically) from the upper flanges 506. The projections 528 are configured for engagement (contact) with the reinforcement member 200 in order to inhibit rotation of the support brackets 500 in relation to the reinforcement member 200 and the apron bracket 400 upon the application of torque thereto (e.g., during connection of the mechanical fasteners 522). More specifically, the projections 528 are configured for insertion into corresponding openings 206 (FIG. 3) (e.g., slots 208) that are formed in (defined by) the reinforcement member 200, which facilitates installation of the support brackets 500 by maintaining alignment between the retainers 520 (FIG. 4) and the apertures 402 (FIG. 3) in the apron bracket 400.

With continued reference to FIGS. 1-4, a method of assembling the vehicle 10 will be discussed.

Initially, the reinforcement member 200 (FIG. 1) and the apron bracket 400 are connected to the vehicle body 100. Thereafter, the support brackets 500 are connected to the apron bracket 400 and the reinforcement member 200 such that the outer support brackets 500O (FIG. 2) are generally aligned with the front lamps 304 (FIG. 1). More specifically, during connection of the support brackets 500, the projections 528 (FIGS. 3, 4) are inserted into the openings 206 (FIG. 3) in the reinforcement member 200, which aligns the retainers 520 (FIG. 4) and the apertures 526 with the apertures 402, 204 (FIG. 3) in the apron bracket 400 and the reinforcement member 200, respectively, and inhibits rotation of the support brackets 500 in relation to the apron bracket 400 and the reinforcement member 200, thereby maintaining proper alignment. The mechanical fasteners 522 (FIG. 3) are then inserted through the retainers 520 and into the apertures 402 in the apron bracket 400 in order to connect the lower flanges 504 thereto, and the mechanical fasteners 532 are inserted through the apertures 526 and into the apertures 204 in the reinforcement member 200 in order to connect the upper flanges 506 thereto. As indicated above, upon connection of the support brackets 500 to the apron bracket 400 and the reinforcement member 200, the flanges 504, 506 extend in generally opposite directions and in generally parallel relation to each other.

Either prior or subsequent to connection of the support brackets 500, the front bumper assembly 300 (FIG. 1) is connected to the vehicle body 100 such that the apron bracket 400 extends into the fascia subassembly 302.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (i.e., an angle that lies within the range of (approximately) 135° to (approximately) 225°) and the term “generally orthogonal” should be understood as referring to configurations in with the pertinent components are oriented so as to define an angle therebetween that is equal to 90°±25% (i.e., an angle that lies within the range of (approximately) 67.5° to (approximately) 112.5°). The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A vehicle comprising:
a vehicle body;
a reinforcement member supported by the vehicle body and configured to absorb forces during an impact with the vehicle;
a front bumper assembly supported by the vehicle body, wherein the front bumper assembly includes:
a fascia subassembly;
front lamps supported by the fascia subassembly; and
a grille subassembly supported by the fascia subassembly;
an apron bracket supported by the vehicle body and the fascia subassembly such that the apron bracket extends therebetween to thereby strengthen the fascia subassembly and improve pedestrian impact performance; and
support brackets extending between the reinforcement member and the apron bracket to thereby inhibit movement of the front bumper assembly in relation to the vehicle body.

2. The vehicle of claim 1, wherein the support brackets include generally S-shaped configurations.

3. The vehicle of claim 2, wherein the support brackets are generally identical in configuration.

4. The vehicle of claim 2, wherein the support brackets include:
trunks;
first flanges extending from the trunks in generally orthogonal relation thereto; and
second flanges extending from the trunks in generally orthogonal relation thereto.

5. The vehicle of claim 4, wherein the first flanges extend in a first direction, and the second flanges extend in a second direction opposite to the first direction.

6. The vehicle of claim 4, wherein the first flanges include retainers configured to receive first mechanical fasteners to thereby connect the support brackets to the apron bracket.

7. The vehicle of claim 6, wherein the retainers are fixedly connected to the first flanges.

8. The vehicle of claim 6, wherein the second flanges include apertures extending therethrough configured to receive second mechanical fasteners to thereby connect the support brackets to the reinforcement member.

9. The vehicle of claim 8, wherein the second flanges further include:
projections extending outwardly therefrom and configured for engagement with the reinforcement member to inhibit rotation of the support brackets in relation to the reinforcement member and the apron bracket.

10. The vehicle of claim 9, wherein the reinforcement member includes openings configured to receive the projections.

11. A vehicle comprising:
a vehicle body;
a reinforcement member supported by the vehicle body and configured to absorb forces during an impact with the vehicle;
a front bumper assembly supported by the vehicle body and including front lamps;
an apron bracket supported by the vehicle body and extending into the front bumper assembly; and
support brackets extending between the reinforcement member and the apron bracket to thereby inhibit movement of the front bumper assembly in relation to the vehicle body.

12. The vehicle of claim 11, wherein the support brackets include outer support brackets positioned in general alignment with the front lamps along a width of the vehicle.

13. The vehicle of claim 12, wherein the support brackets further include:
at least one inner support bracket positioned between the outer support brackets.

14. The vehicle of claim 13, wherein the at least one inner support bracket is generally centered along the width of the vehicle.

15. The vehicle of claim 11, wherein the support brackets include:
trunks; and
upper and lower flanges extending from the trunks in generally opposite directions and in generally parallel relation.

16. A method of assembling a vehicle, the method comprising:
connecting an apron bracket to a vehicle body;
connecting a reinforcement member to the vehicle body, wherein the reinforcement member is configured to absorb impact forces;
connecting support brackets to the apron bracket and the reinforcement member such that the support brackets extend therebetween; and
connecting a front bumper assembly to the vehicle body such that the apron bracket extends into the front bumper assembly, whereby the support brackets inhibit movement of the front bumper assembly in relation to the vehicle body.

17. The method of claim 16, wherein connecting the support brackets to the apron bracket and the reinforcement member includes connecting first flanges to the apron bracket and connecting second flanges to the reinforcement member such that the first flanges and the second flanges extend in generally opposite directions.

18. The method of claim 16, wherein connecting the support brackets to the reinforcement member includes inserting projections extending outwardly from the support brackets into openings in the reinforcement member to thereby inhibit rotation of the support brackets in relation to the reinforcement member and the apron bracket.

19. The method of claim 16, wherein connecting the support brackets to the apron bracket and the reinforcement member includes connecting outer support brackets to the apron bracket and the reinforcement member such that the outer support brackets are generally aligned with front lamps of the vehicle.

20. The method of claim 19, wherein connecting the support brackets to the reinforcement member and the apron bracket includes connecting at least one inner support bracket to the reinforcement member and the apron bracket such that the at least one inner support bracket is positioned between the outer support brackets.
